(19) United States
(12) Patent Application Publication
(10) Pub. No.: US 2015/0324442 A1
(43) Pub. Date: Nov. 12, 2015

(54) SYSTEM FOR AUTOMATED MATERIAL MASTER DATA HARMONIZATION

(71) Applicants: Digesh Panchal, MUMBAI (IN); Nitin Patil, MUMBAI (IN); Amit Shinde, MUMBAI (IN)

(72) Inventors: Digesh Panchal, MUMBAI (IN); Nitin Patil, MUMBAI (IN); Amit Shinde, MUMBAI (IN)

(21) Appl. No.: 14/306,383

(22) Filed: Jun. 17, 2014

(30) Foreign Application Priority Data
May 7, 2014 (IN) 1579/MUM/2014

(51) Int. Cl. G06F 17/30

(52) U.S. Cl. CPC G06F 17/30598; G06F 17/30867; G06F 17/30525

(57) ABSTRACT

A system for automated material master data harmonization that is extremely configurable and easy-to-use solution to standardize, normalize, attribute, rationalize and enrich the organization's material master data using embedded knowledge that leverages enterprise knowledge assets. The system provides various customer centric systems and processes by providing harmonization of data with dependencies of important embodiments such as data classification and MFR-MPN extraction that are not dependent on any other stage. Attribute extraction is dependent on data classification and data sheet definition. Post processing is dependent on data classification, data sheet definition and attributes extraction. Identify L2 dups is dependent on data classification, data sheet definition, attribute extraction and post processing. Non-Source enrichment and Identify L1 dups are dependent on MFR-MPN extraction.

### CROSS-REFERENCE TO RELATED APPLICATION

The instant application claims priority to Indian Patent Application Serial No. 1579/MUM/2014, filed May 7, 2014, pending, the entire specification of which is expressly incorporated herein by reference.

### FIELD OF THE INVENTION

The present invention relates generally to data processing and to distributing data in data management systems, and more particularly to a system for automated material master data harmonization.

### BACKGROUND OF THE INVENTION

Information technology (“IT”) environments can consist of many different systems performing processes, such as business processes, on common master data. The different systems can be part of the same entity or can be part of different entities, such as vendors or contractors. The master data used for the processes can be stored in a number of different locations, systems, and/or incompatible formats. Branch offices of a company can work largely independently, adopted companies can introduce new software solutions to a group of affiliated companies, and systems from different vendors can be linked. Different master data models can make it difficult to integrate business processes in these scenarios.

Master data can become trapped and siloed in different systems. Master data that is not aligned across an IT environment can lead to data redundancies and irrelevant or incorrect information.

Businesses today are more data and analytics driven, and many of them seek enrichment of their internal data records with data from data sources available from the manufacturer, the Internet, and any other information. The goal of this exercise is almost always to get specific descriptions about the current inventory that aids in spend-analysis.

Hence, harmonization classifies the data to begin with, and moves to extract specific attributes and manufacturer information. There is a process to search for alternative data sources on the Internet as well. All of these processes converge to generate more specific descriptions of the item.

Because the data is processed in quite a few ways, data ambiguity is almost negligible and finding duplicate records is easier, therefore there exists a need to have a system to harmonize and attempt to find duplicates at two levels, one being for the manufacturer information, and the other for attribute values in order to avoid a negligible margin of error.

### SUMMARY OF THE INVENTION

The main object of the present invention is to provide a system for a one-stop solution for cleansing and enrichment of historical master data.

Yet another object of the present invention is to improve master data quality transforming the data into a productivity lever that drives organizational optimization and improved productivity.

It is another object of the present invention is to overcome data quality challenges such as high volume of data, duplicate entries, multiple languages, non-uniform commodity coding standards, poorly or insufficiently classified data, incomplete data (e.g., missing part numbers), poorly structured descriptions (e.g., inconsistent or missing specifications) and the unique characteristics of parts (e.g., especially MRO) data.

It is yet another object of the present invention to provide a system which is configurable and easy-to-use solution to standardize, normalize, attribute, rationalize and enrich the organization's material master data using embedded knowledge that leverages enterprise knowledge assets.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a screen shot of an attribute extraction page showing the number of total items (hereinafter referred to as “SKU”) or SKUs along with the number of categories. It also shows the percentage of SKUs for which the attribute values have been extracted and for those that are un-extracted.

FIG. 2 is a screen shot of an attribute quality check, wherein the attributes that are marked in highlighting (e.g., colored red) are critical attributes for that record, as defined in the data sheet.

FIG. 3 is a screen shot of non-source enrichment showing the total number of SKUs with the number of SKUs that have been searched on the Internet. It is also shows the number of SKUs that have been enriched using the non-source data from the Internet. The searches on the Internet for the SKUs are segregated into Hits and No Hits based on whether results are obtained or not. The data will be populated after the search on the Internet is done using auto crawl.

FIG. 4 is a screen shot of data enrichment by categories showing all SKUs segregated category wise, as well as the percentage of attribute values present.

FIG. 5 is a screen shot showing enriched results with its attribute values on that website, wherein these values could be used as a web attribute value for the record to be enriched.

FIG. 6 is a screen shot showing records that have the same MFR-MPN match are affected and records that have been enriched are denoted by the symbol [symbol] and the ones that are bypassed are denoted by the symbol [symbol] . Pending (e.g., neither bypassed nor enriched) records are denoted by the symbol [symbol] .

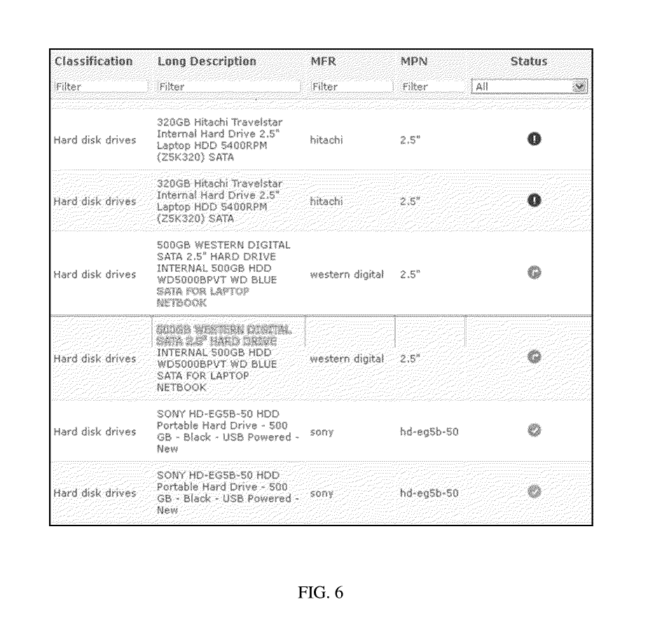

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

The present invention provides a system for automated material master data harmonization that is extremely configurable and easy-to-use solution to standardize, normalize, attribute, rationalize and enrich the organization's material master data using embedded knowledge that leverages enterprise knowledge assets. As previously noted, it is well-known that fetching different data source for data enrichment is a real challenge. Although, enormous data sources are available on Internet but collating them to enrich the data description is a real challenge.

The present invention provides various customer centric systems and processes by providing harmonization of data with dependencies of important embodiments of the present invention such as data classification and MFR-MPN extraction are not dependent on any other stage; attribute extraction is dependent on data classification and data sheet definition. Post processing is dependent on data classification, data sheet definition and attributes extraction. Identify L2 dups is dependent on data classification, data sheet definition, attribute extraction and post processing. Non-Source enrichment and Identify L1 dups are dependent on MFR-MPN extraction.

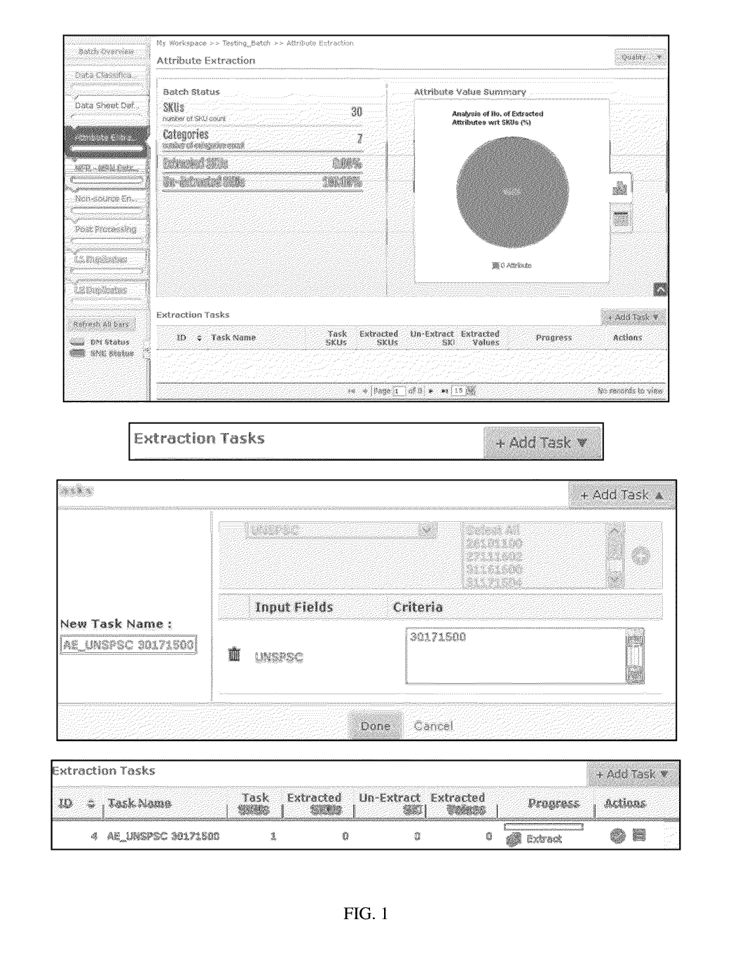

As shown in FIG. 1, there is provided an attribute extraction step showing the number of total items (hereinafter refers to as SKU) along with the number of categories. It also shows the percentage of SKUs for which the attribute values have been extracted and for those that are un-extracted. Thus, an attribute is a technical characteristic of an item. An attribute helps distinguish one item from the other. For example, a roller bearing and a ball bearing are of the same category i.e., bearing; however, the attributes of both types of bearings differ in one being a roller type and the other a ball type. This step enables extracting and displaying the attributes of an item that will help in generating an enriched description by harmonizing enabling scanning the short and long descriptions along with relevant input data fields specified during the import of the batch data as well specifying certain criterions to extract attributes. As illustrated in FIG. 1, attributes can be extracted for a particular item or for group of items together by adding a task for extraction.

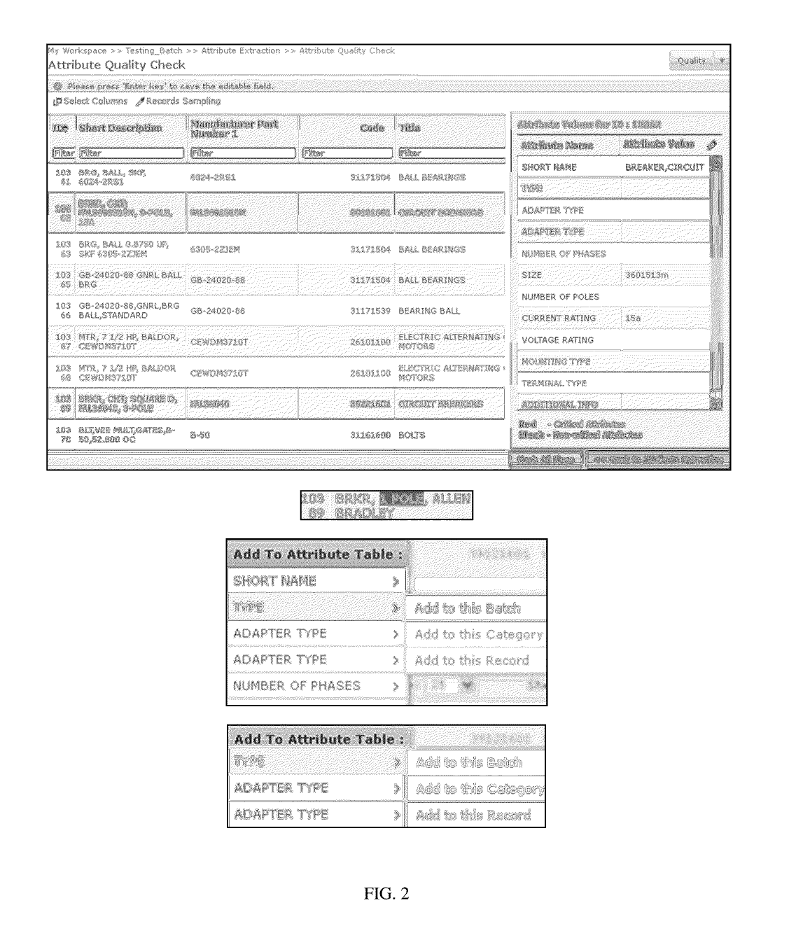

Further, as shown in FIG. 2, wherein it illustrates an attribute quality check wherein the attributes that are highlighted (e.g., marked in red) are critical attributes for that record, as defined in the data sheet. Thus, if attribute values are not extracted for certain attributes, a user can specify those values from the record or by entering them manually in the attribute table on the right. The values that user specify for an attribute from the record is applied to the attribute table in either batch wise wherein the attribute values are added to the attribute table for all the available batches and or by category wise wherein the attribute values are added to the attribute table for relevant category and or by record wise wherein the attribute values are added to the attribute table only for respective record.

In order to specify the attribute values, the required text is selected from the description field required for extraction such as a short description. For adding an attribute to the given table, a pop up is displayed that has all attributes that are defined for a data sheet to which the value is be added, in either of batch, category and record ways.

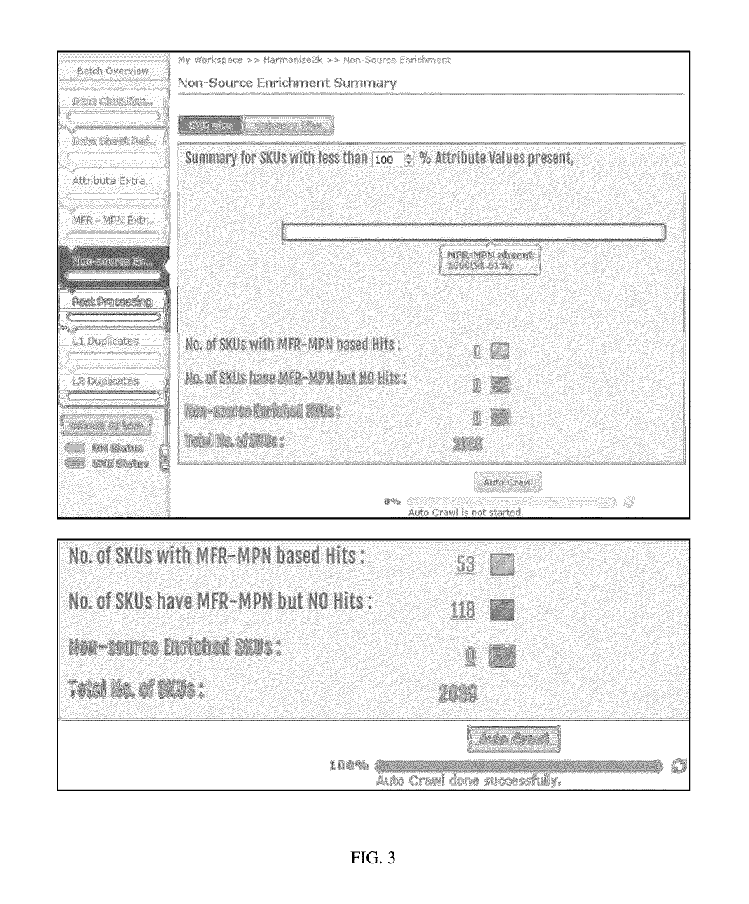

Further, as shown in FIG. 3, non-source enrichment showing the total number of SKUs with the number of SKUs that have been searched on the Internet; it is also shows the number of SKUs that have been enriched using the non-source data from the Internet. The searches on the Internet for the SKUs are segregated into Hits and No Hits based on whether results are obtained or not. The data will be populated after the search on the Internet is done using auto crawl. The input data may have certain sets of attributes that may be missing in order to correct those anomalies, the non-source enrichment attempts to enrich the input data using varied data sources present on the Internet. This process entails searching the Internet for the MFR-MPN match and displaying the findings thereby to analyze and either enriches the data attributes with the ones found on the web or to bypass the web-found attributes and retain the source information. The user is able to specify the least percentage of attribute values that should be present.

The Internet search depends upon the criteria user set for the percentage of attribute values to be present. For example, if all attribute values are present for an item, then a search for that item on the Internet may be redundant. Hence, it is important to analyze the minimum percentage of attribute values that may be required to generate optimum short and long descriptions. In cases where descriptions generated from 60% attribute values suffice, a search for SKUs with less than 60% attribute values is adequate.

For example, if an item that has eight attributes and five attribute values, i.e., more than 60% is enough to generate a description per your requirements, then searching all other SKUs with less than 60% attribute values present should give the user relevant results for enrichment of SKUs. In order to access the non-source enrichment page, the user may click non-source enrichment in the flowchart of stages.

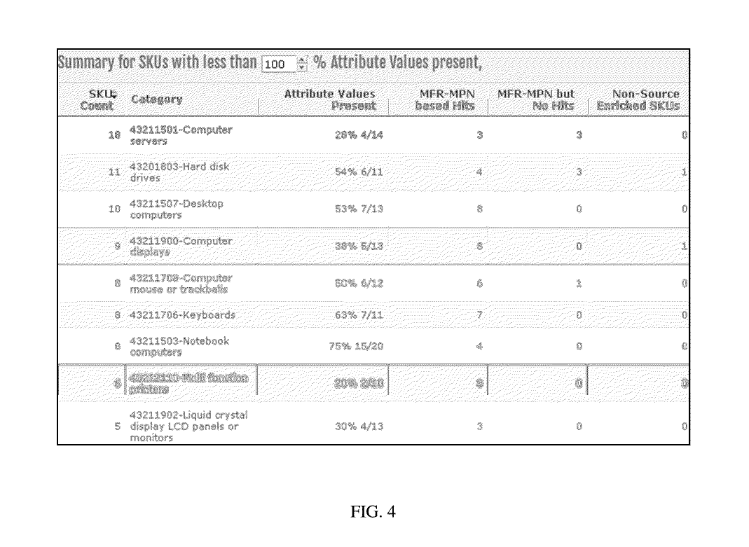

As shown in FIG. 4, data enrichment by categories showing all SKUs segregated category wise, as well as the percentage of attributes values present. Therefore, searching the total number of SKUs returns the number of SKUs having MFR-MPN match and also whether the search on the Internet results in any hits. The user is able to enrich the SKUs with attribute values found from the Internet. Therefore, the results that are directly obtained on classified as hits and results obtained that do not directly return attribute based values are classified as no hits.

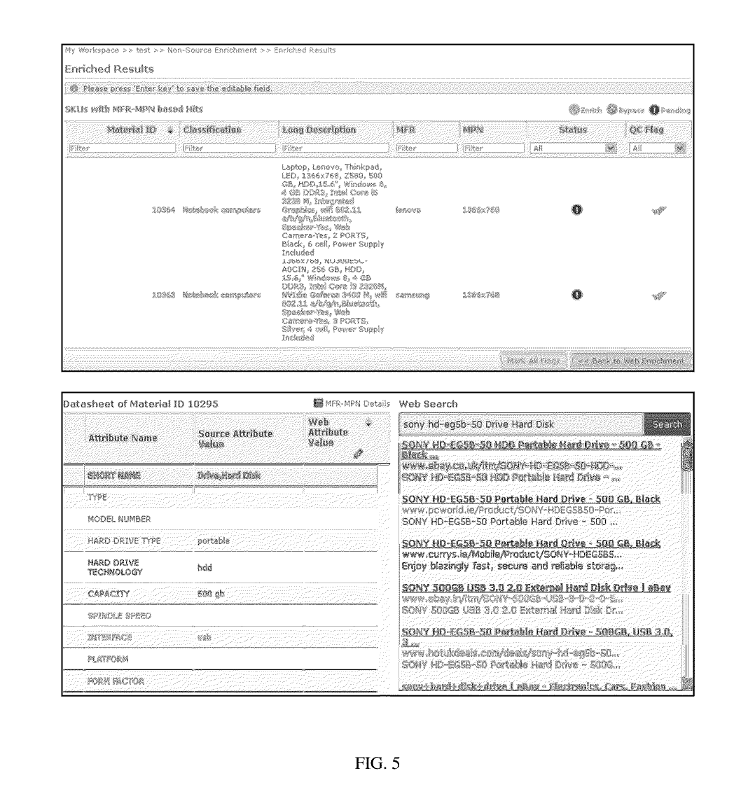

Thus, the number of SKUs with MFR-MPN based Hits show the number of SKUs, wherein the MFR-MPN based search has returned attribute based results. Similarly, the number of SKUs has MFR-MPN but no Hits show the number of SKUs, wherein the MFR-MPN match exists but the MFR-MPN based search has not returned any relevant results and the non-source enriched SKUs shows the number of SKUs that have been enriched using the attribute values found from the Internet. As also shown in FIG. 5, wherein the enriched results with its attribute values on that website, these values could be used as a web attribute value for the record to be enriched. The user is able to view the records that have the same MFR-MPN match are affected and records that have been enriched are denoted by the symbol [symbol] and the ones that are bypassed are denoted by the symbol [symbol] . Pending (e.g., neither bypassed nor enriched) records are denoted by the symbols [symbol] .

While the present invention has been described herein as relating to a suite of web-based applications with appropriate software layering to database repositories (that may constitute hard drives, tape drives, etc.), the data harmonization need not necessarily be a web application and instead may use another user interface-based application suite integrated with the underlying data repositories. The data harmonization also need not be located in one particular region; instead, and depending on the implementation, a business entity may distribute the harmonization functionality and available among a plurality of geographical areas.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for automated material master data harmonization, comprising:
attribute extraction;
attribute quality check;
non-source enrichment;
data enrichment; and
enriched results with its attribute values for harmonization of data with dependencies such as data classification and MFR-MPN extraction that are not dependent on any other stage.

2. The system as claimed in claim 1, wherein an attribute extraction shows the number of total items denoted as a SKU, along with the number of categories having percentage of SKUs for which the attribute values have been extracted and for those that are un-extracted.

3. The system as claimed in claim 1, wherein an attribute extraction enables extracting and displaying the attributes of an item that is for generating an enriched description by harmonizing enabling scanning the short and long descriptions along with relevant input data fields specified during the import of the batch data as well specifying certain criterions to extract attributes.

4. The system as claimed in claim 1, wherein an attribute quality check enables a user to define checks such that, if attribute values are not extracted for certain attributes, the user can specify those values from the record or by entering them manually in an attribute table on a right side, said values that the user specifies for an attribute from the record is applied to the attribute table in either batch wise, wherein the attribute values are added to the attribute table for all the available batches or by category wise, wherein the attribute values are added to the attribute table for relevant category or by record wise, wherein the attribute values are added to the attribute table only for a respective record.

5. The system as claimed in claim 1, wherein in order to specify the attribute values, a required text is selected from a description field required for extraction including a short description, whereby adding an attribute to a given table causes a pop up to be displayed that has all attributes that are defined for a data sheet to which the value is be added, in either of batch, category and record ways.

6. The system as claimed in claim 1, wherein non-source enrichment enriches the input data using multiple data sources present on the Internet by searching the Internet for a MFR-MPN match and displaying the findings thereby to analyze and either enrich the data attributes with the ones found on the Internet or to bypass the Internet-found attributes and retain the source information.

7. The system as claimed in claim 1, wherein data enrichment enables enrichment of the SKUs with attribute values found from the Internet, thereby the results that are directly obtained on searching the MFR-MPN match are classified as hits and results obtained that do not directly return attribute based values are classified as no hits.

8. The system as claimed in claim 1, wherein the number of SKUs with MFR-MPN based hits show the number of SKUs, whereas the MFR-MPN based search has returned attribute based results similarly, the number of SKUs has MFR-MPN but no hits show the number of SKUs, wherein the MFR-MPN match exists but the MFR-MPN based search has not returned any relevant results and the non-source enriched SKUs shows the number of SKUs that have been enriched using the attribute values found from the Internet.

9. The system as claimed in claim 1, wherein the enriched results with its attribute values on that website is used as a web attribute value for the record to be enriched thereby a user is able to view the records that have the same MFR-MPN match are affected and records that have been enriched.
